(19) United States
(12) Patent Application Publication
(10) Pub. No.: US 2014/0068456 A1
(43) Pub. Date: Mar. 6, 2014

(54) CUSTOMIZED LOGIN INTERFACE

(71) Applicant: Google Inc., Mountain View, CA (US)

(72) Inventors: Min Li CHAN, San Francisco, CA (US); Nikita KOSTYLEV, Moscow (RU); Kenneth Brian MOORE, Seattle, WA (US); John Nicholas JITKOFF, Palo Alto, CA (US)

(73) Assignee: Google Inc., Mountain View, CA (US)

(21) Appl. No.: 13/831,011

(22) Filed: Mar. 14, 2013

Related U.S. Application Data
(60) Provisional application No. 61/697,748, filed on Sep. 6, 2012.

(51) Int. Cl. G06F 3/0484

(52) U.S. Cl. CPC G06F 3/0484
USPC 715/747

(57) ABSTRACT

Various aspects of the subject technology relate to systems, methods, and machine-readable media for providing a customized background in a user interface based on a selection of a user login option. A system can be configured to identify at least a first user and a second user of a computing machine, display a first background for the first user in a user login interface comprising at least a first user login option for the first user and a second user login option for the second user, receive a selection of the second user login option for the second user, and replace, in response to the receiving of the selection, the first background for the first user in the user login interface with a second background for the second user.

### RELATED APPLICATION

This application claims priority to U.S. Provisional Patent Application No. 61/697,748, filed on Sep. 6, 2012, “USER INTERFACE TRANSITIONS,” the contents of which are herein incorporated by reference in its entirety.

### BACKGROUND

The present disclosure generally relates to user interfaces and, in particular, to user interfaces displayed during user transitions from one state to another.

Computing devices often go through a number of computing states. For example, a computing device may be in an off state, a booting-up state, a locked state, a logged-in state, an operational state, a logging-off state, a shutting down state, or any other computing state. Many computing states may also be made of several smaller computing states (e.g., sub-states).

For each computing state, a user viewing a display associated with the computing device may be presented with a different experience. For example, when a computing device is booting up, the display may show a black screen, a company logo, an icon or image associated with the booting process, or a combination of different screens. After the computing device is booted up, but before a user has logged in, the user may be presented with a sign on screen or another screen associated with the computing device's locked state. After a user logs in, the computing device may be in an operational state and display a user interface with a desktop background. Similarly, different screens may be displayed when a user logs off or when the computing device shuts down.

### SUMMARY

Various aspects of the subject technology relate to a system for providing a customized background in a user interface based on a selection of a user login option. The system includes one or more processors and a machine-readable medium comprising instructions stored therein, which when executed by the one or more processors, cause the one or more processors to perform operations. The operations include identifying at least a first user and a second user of a computing machine, displaying a first interface element for the first user in a user login interface comprising at least a first user login option for the first user and a second user login option for the second user, receiving a selection of the second user login option for the second user, and replacing, in response to the receiving of the selection, the first interface element for the first user in the user login interface with a second interface element for the second user.

Other aspects of the subject technology relate to a method for providing a customized background in a user interface based on a selection of a user login option. The method includes identifying at least a first user and a second user of a computing machine, displaying a first background for the first user in a user login interface comprising at least a first user login option for the first user and a second user login option for the second user, receiving a selection of the second user login option for the second user, and replacing, in response to the receiving of the selection, the first background for the first user in the user login interface with a second background for the second user.

Various aspects of the subject technology relate to a non-transitory machine-readable medium comprising instructions stored therein, which when executed by a machine, cause the machine to perform operations for providing a background in a user interface based on a selection of a user login option. The operations may include identifying at least a first user and a second user of a computing machine, wherein the first user is a user that most recently logged into the computing machine, displaying a first background for the first user in a user interface comprising at least a first user login option for the first user and a second user login option for the second user, receiving a selection of the second user login option for the second user, and displaying, in response to the receiving of the selection, a second background for the second user in the user interface.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding of the subject technology and are incorporated in and constitute a part of this specification, illustrate disclosed aspects of the subject technology and together with the description serve to explain the principles of the subject technology.

FIG. 1 is an illustration of an example user interface showing a log on screen, in accordance with various aspects of the subject technology.

FIG. 2 is an illustration of an example user interface showing a log on screen with a selected user login option, in accordance with various aspects of the subject technology.

FIG. 3 is an illustration of an example user interface showing a log on screen with a selected user login option, in accordance with various aspects of the subject technology.

FIG. 4 is a block diagram illustrating an example system configured to provide a customized background in a user interface based on a selection of a user login option, in accordance with various aspects of the subject technology.

FIG. 5 is a flow chart illustrating an example process for providing a customized background in a user interface based on a selection of a user login option, in accordance with various aspects of the subject technology.

FIG. 6 is an illustration of an example user interface showing a user interface for an operational state of a computing device, in accordance with various aspects of the subject technology.

FIG. 7 is an illustration of an example user interface showing a user interface for a locked state of a computing device, in accordance with various aspects of the subject technology.

FIG. 8 is a block diagram illustrating an example system configured to provide a transition from a user interface displayed during a first computing state to a user interface displayed during a second computing state, in accordance with various aspects of the subject technology.

FIG. 9 is a flow chart illustrating an example process for providing a transition from a user interface displayed during a first computing state to a user interface displayed during a second computing state, in accordance with various aspects of the subject technology.

FIG. 10 is a block diagram illustrating an example computer system with which any of the computing machines, devices, or systems discussed herein may be implemented, in accordance with some aspects of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent that the subject technology may be practiced without these specific details.

A computing device (e.g., a laptop, a computer, a smart television, a smart phone, etc.) may provide for different user interfaces to be shown on associated display (e.g., a laptop display, a monitor, a television, a touch screen) during different computing states. However, in some cases, it may be advantageous to display the same or similar user interface during different computing states and during the transitions between computing states. For example, some users may find viewing different and unrelated user interfaces during different computing states to be jarring. Having the same or similar user interface with similar design elements may be perceived by users to be more fluid and have better continuity. Furthermore, it may be advantageous to have the user interfaces shown during the different computing states to be customized to a user.

Various aspects of the subject technology relate to systems and methods for providing a customized background in a user interface based on a selection of a user login option. Background may include, for example, images, applications providing a live wallpaper, a collection of images that may be intermittently displayed, or other visual elements to be displayed on a computer display desktop.

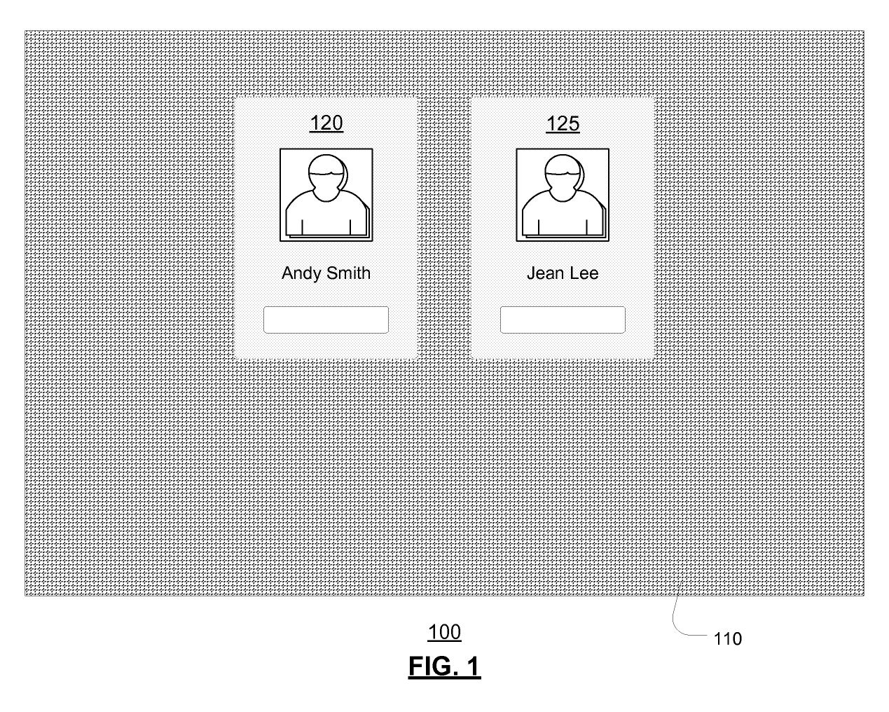

FIG. 1 is an illustration of an example user interface 100 showing a log on screen, in accordance with various aspects of the subject technology. The user interface 100 showing the log on screen may be provided for display when a computing device finishes booting up in response to being turned on or restarted, when a previous user logs out, or for any number of other reasons.

The user interface 100 may also display one or more user login options. A login option may be in the form of a user pod, which is a user interface element that contains various information about a user and allows the user to sign into a computing device. For example, in FIG. 1, two user login options are shown: one user login option 120 for user “Andy Smith” and one user option 125 for user “Jean Lee.” Each login option may include various pieces of information associated with a user of the computing device. For example, the login option may include the name of the user, a profile picture for the user, or profile information for the user. Additionally, each login option may include a field configured to receive a user's login password or other information used to authenticate a user.

Initially, the user interface may display a background 110 of the last user that successfully logged in. In the example of FIG. 1, background 110 is associated with user “Andy Smith,” the last user to successfully log into the computing device. A new user may select one of the user login options 120 and 125 and, in response to the selection, the computing device may display the background associated with the selected user login option. For example, a new user may select user login option 125 in FIG. 1 associated with the user “Jean Lee.” In response to the selection, the computing device may identify a background (e.g., a background image) associated with the user “Jean Lee” and display the background in the user interface 100.

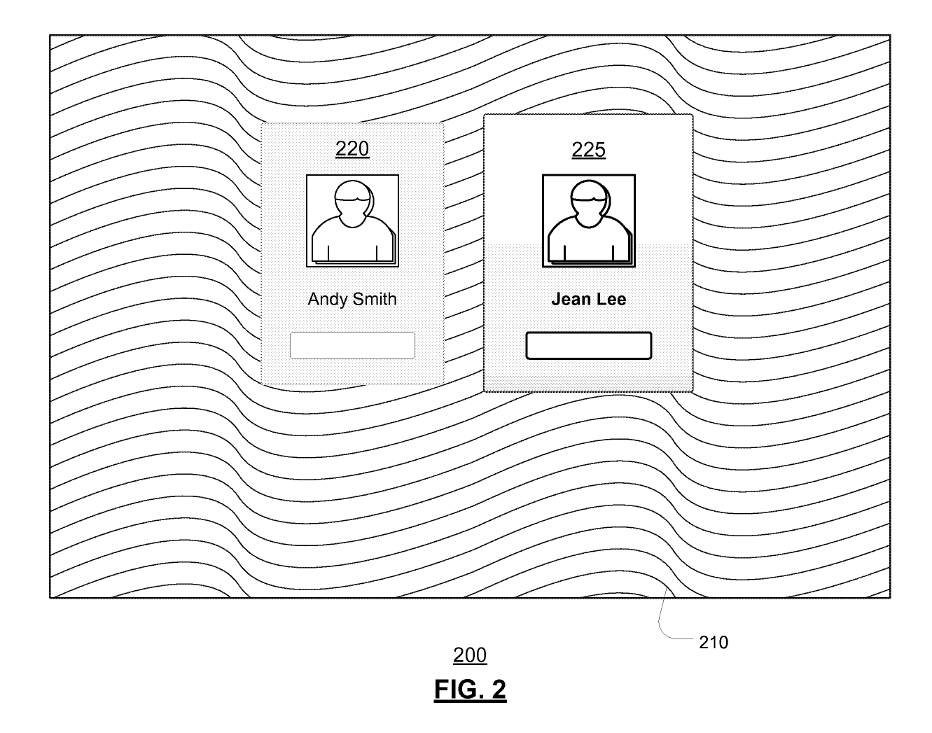

FIG. 2 is an illustration of an example user interface 200 showing a log on screen with a selected user login option, in accordance with various aspects of the subject technology. In FIG. 2, user login option 225 is selected and, accordingly, the computing device may change the displayed background to the background image 220 associated with the selected user login option 225 for display.

According to some aspects, the selected user login option 225 may also be displayed with one or more visual indications signaling to a viewer that user login option 225 is selected. In FIG. 2, for example, user login option 225 appears larger than the unselected user login option 220. In other aspects, the visual indication signaling that a user login option is selected may include highlighting the user login option, displaying the user login option in bold, displaying the use login option with an icon or symbol, or any other type of visual indication.

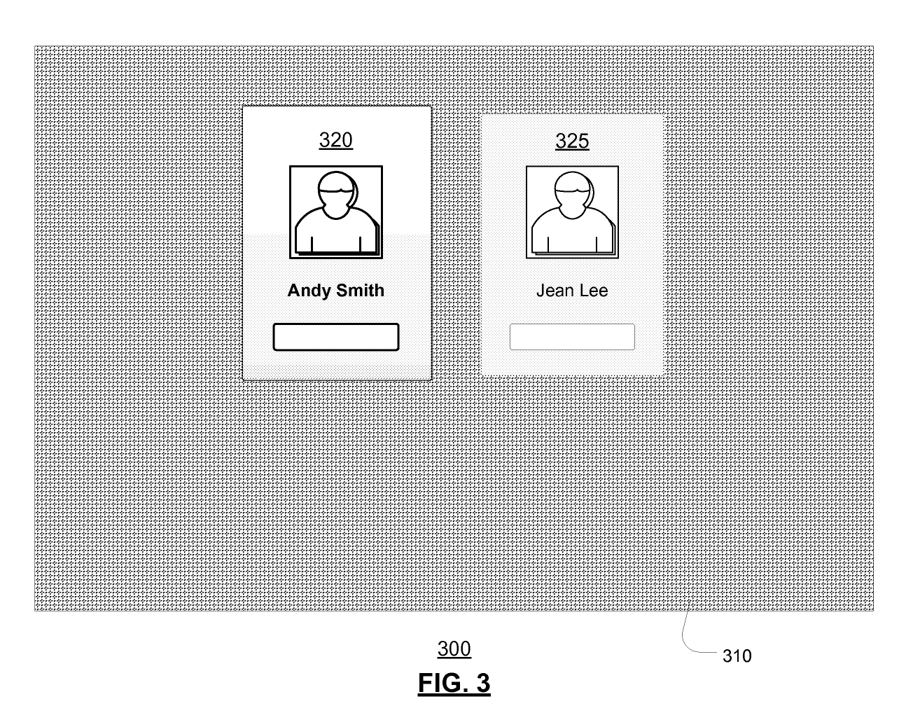

The new user may also select the other login option 220 in FIG. 2. In response to the new selection of login option 220 associated with user “Andy Smith,” the computing system may identify a background associated with the user “Andy Smith” and display the background in the user interface 200. For example, FIG. 3 is an illustration of an example user interface 300 showing a log on screen with a selected user login option, in accordance with various aspects of the subject technology. In FIG. 3, the login option 320 for user “Andy Smith” appears selected, the login option 325 for user “Jean Lee” appears unselected, and the background 310 associated with “Andy Smith” is displayed in the user interface 300.

Although the user interfaces in FIG. 1, FIG. 2, and FIG. 3 show two user login options (e.g., login pods), in other aspects, any number of user login options may be used. Furthermore, although in some aspects described above, a different background (e.g., a background image) based on a selected user login option is displayed, other user interface elements, in addition to or instead of a background, may also be customized and selected for display based on a particular user login option. Other user interface elements may include, for example, task bars, icons, application lists, utility trays, or any other customizable user interface element.

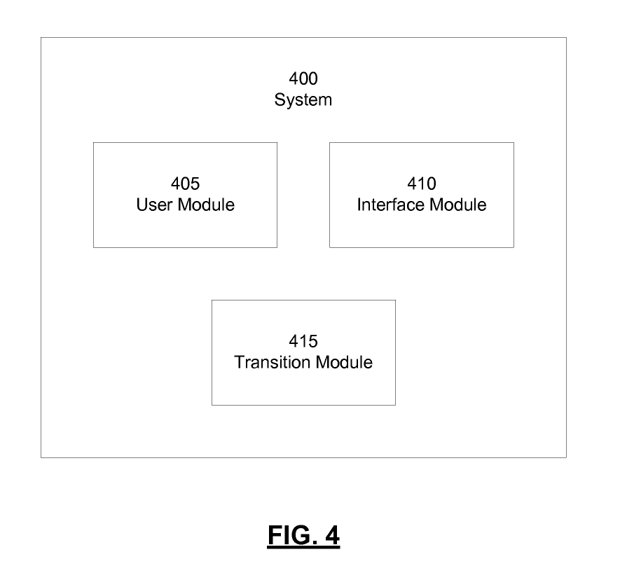

FIG. 4 is a block diagram illustrating an example system 400 configured to provide a customized background in a user interface based on a selection of a user login option, in accordance with various aspects of the subject technology. The system 400 may include a user module 405, an interface module 410, and a transition module 415. In other aspects, however, the system may include additional modules, alternative modules, or fewer modules.

The user module 405 is configured to manage user of a computing machine (e.g., a laptop, a tablet, a computer, a smart television, a smart phone, a mobile device, etc.). The user module may store a profile for each user that includes, for example, a user name, a login password, a background for the user, a profile picture, user preferences and/or settings, and any other information related to the user. The user module 405 can also identify which user was the last user to have successfully logged into the computing machine.

The interface module 410 is configured to display various interface elements in a user interface. The interface elements may include backgrounds and user login options for users as well as, in some variations, toolbars, icons, clocks, or other interface elements. For example, when a computer starts up, is restarted, or is logged out of, the interface module 410 may display the background of the last user to have successfully logged into the computing machine. The interface module 410 may also display the login options for users of the computing machine over the background.

The transition module 415 is configured to change the various interface elements displayed in a user interface based on a user selection of at least one of the login options. For example, the transition module 415 can receive a selection of one of the login options. If the selected login option is associated with a different background, the transition module 415 can replace the currently displayed background with the background associated with the selected login option. Otherwise, there may be no need to change the currently displayed background.

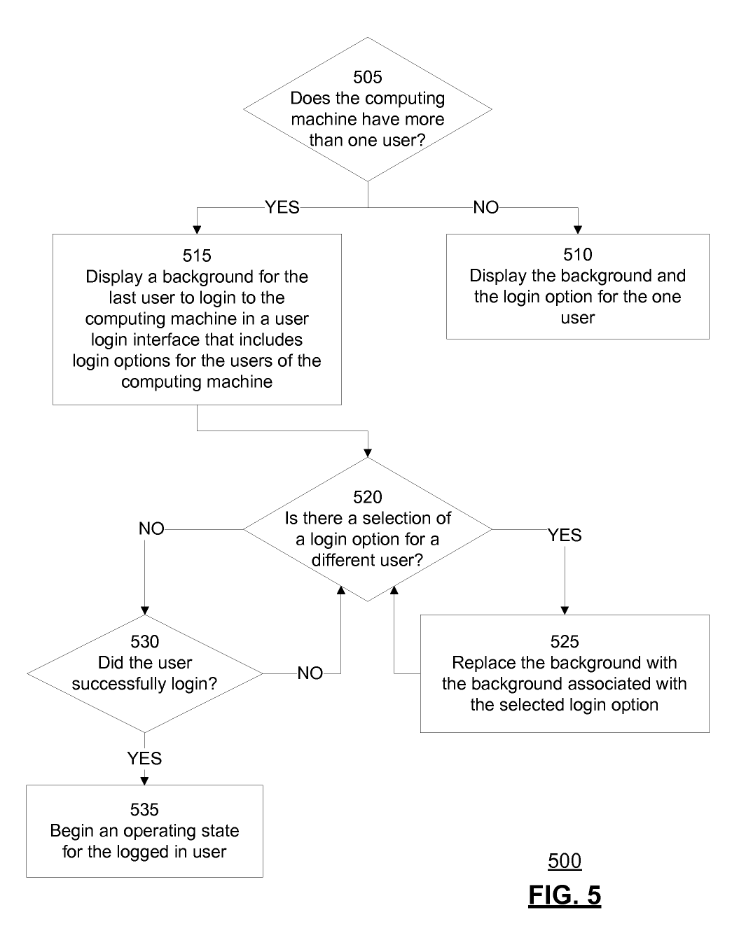

FIG. 5 is a flow chart illustrating an example process 500 for providing a customized background in a user interface based on a selection of a user login option, in accordance with various aspects of the subject technology. Although the process blocks of FIG. 5 are described with reference to the components of the system 400 in FIG. 4, the blocks are not limited to being performed by these components. In addition, although the blocks in process 500 are shown in a particular order, certain blocks may be executed in different orders or at the same time.

At block 505, the user module 405 can determine whether the computing machine has more than one user. If the computing machine only has one user, at block 510, the interface module 410 can display a background for the one user along with a login option for the user. If on the other hand, the computing machine has more than one user, the user module 405 can identify the users, determine which user was the last to successfully login, and display a background for the last user to successfully login to the computing machine in a user login interface at block 515. The user login interface may also include a login option for each user of the computing machine. By default, one of the login options may be active (e.g., the login option for the last user to login). In other aspects, however, none of the login options may be active.

At block 520, the interface module 410 can determine whether a user of the computing machine has selected a login option for a user with a different background than the one currently being displayed. If a login option for different user has been selected, at block 525, the transition module 415 can replace the background currently being displayed with a background associated with the selected login option. In some aspects, the transition module 415 can delay replacing the background for a predetermined period of time in case a number of different login options are being rapidly selected (e.g., a user may be scrolling through the login options to get to a desired login option or a keyboard button may be momentarily stuck). Alternatively, the transition module 415 can delay replacing the background until no further changes in the selection of a login option are detected for a period of time.

Furthermore, in some aspects, the background may be changed gradually (e.g., an old background may fade out and a new background may fade in) or nearly instantaneously. After the background and any other interface elements are replaced, control of the process may return to block 520 to await any further change in selected login options.

If a login option for different user has not been selected, at block 530, the interface module 410 can determine whether the user successfully logged in, for example, by using a password, via biometric information (e.g., a fingerprint, facial or voice recognition, etc.), or through other authentication means. If the user successfully logged in, control of the process may return to block 520 to see of there are any changes in selected login options. Otherwise, if the user successfully logged in, the interface module 410 may begin an operating state for the logged in user at block 535.

In some cases, the user may upload a personal image to use as a background. When the user is selecting an image to use as a background, the user module 405 may determine whether the image might be a personal image. For example, if the image is being uploaded or transferred from a camera or another device, the image may be a personal image.

If the user's background is an uploaded image or a personal image, the user module 405 may notify the user that the background may be shown to other users viewing the user login interface when the user's login option (e.g., the user's login pod) is selected. In other aspects, the user module 405 may provide the user with an option to choose whether or not the user's background will be shown to other users viewing the user login interface. If the user chooses not to have the background shown, the system may provide a default background to be shown on the user login interface when the user's login option is selected.

According to some aspects, the backgrounds for the users may be retrieved from a non-encrypted portion of memory. For example, when a user selects a background image, a copy of the background image may be stored in a non-encrypted portion of memory that will be accessible to the operating system during system boot-up without the user's password. Furthermore, before being copied to the non-encrypted portion of the memory, the user module 405 may perform one or more security processes in order to ensure that the background image does not include any harmful code. For example, the image may be converted into a different format (e.g., a Joint Photographic Experts Group (JPEG) format) and stored on the non-encrypted portion of the memory. During the login phase, the backgrounds for the images may be decoded using a secure decoding library and displayed on the login user interface.

Although in some aspects described above, a different background (e.g., a background image) based on a selected user login option is displayed, other user interface elements, in addition to or instead of a background, may also be customized and selected for display based on a particular user login option. Other user custom interface elements may include, for example, task bars, icons, application lists, utility trays, or any other customizable user interface element.

By displaying different interface elements based on a selected user login option, the computing system is able to provide users with a personalized view of the user interface. The personalized view of the user interface may also server as a visual affirmation that the user has selected the correct user login option. Furthermore, by showing the user the interface element associated with that user, the login user interface will appear more similar to other user interfaces shown in other computing states. For example, the background shown in the login interface may be the same background as shown during the booting stage and as shown in an operating stage. By showing similar user interfaces, the user is provided a more continuous and consistent user experience with more fluid transitions from one computing state to another.

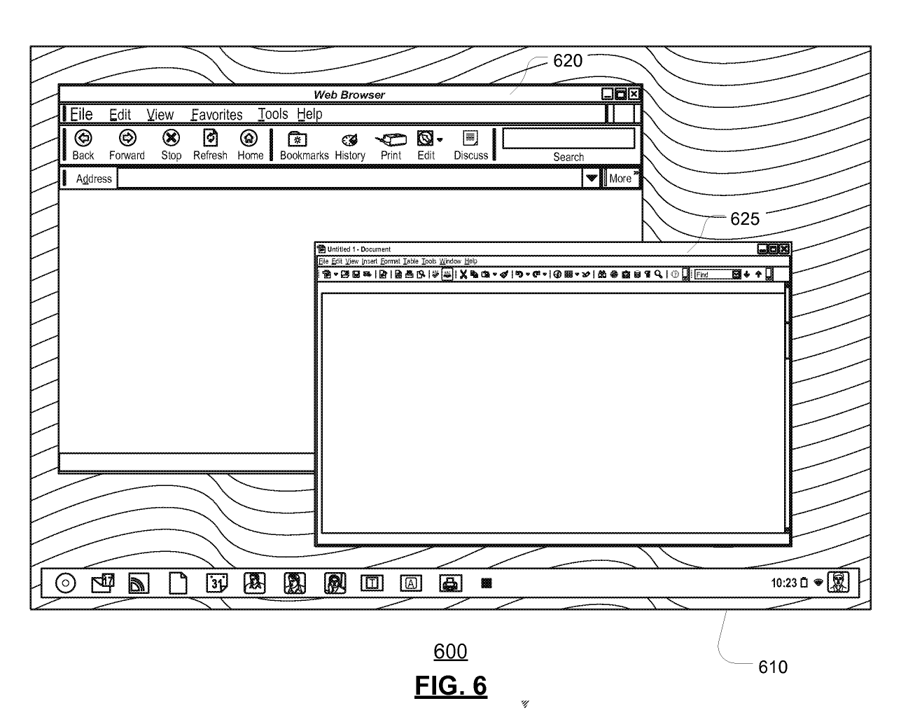

Referring back to FIG. 2, if user “Jean Lee” logged into the computing device using user login option 225, the user would be presented with a user interface that has the same background (see background 610 in FIG. 6) as the background 210 on the login user interface when the user login option for “Jean Lee” is selected. For example, FIG. 6 is an illustration of an example user interface 600 showing a user interface for an operational state of a computing device, in accordance with various aspects of the subject technology. After logging in, the user may be shown the user interface 600 (e.g., a desktop) for the operational state. The user interface 600 for the operational state may have the same background 610 that is associated with the user as was shown in the login state of the computing machine.

In the operational state, the user may open various applications which may appear as windows 620 and 625 on the user interface 600. In some cases, during the operation of the computing device, the computing device may transition into a locked state. For example, the computing device may enter a locked state in response to a user instruction, in response to not receiving user input (e.g., being idle) for a certain period of time, or for any other reason.

Various aspects of the subject technology relate to providing, on a user interface, a transition from an operating state to a locked state. Some aspects may provide a seamless and fluid transition from an operating state to a locked state with a consistent visual experience. The computing device may detect a lock condition and, in response to the lock condition, the computing device may remove the windows 620 and 625 from the user interface 600.

According to some aspects, instead of instantaneously removing the windows from the user interface 600, the computing device may show the windows 620 and 625 in a process of being removed from the user interface 600, so as to achieve a more fluid user experience. For example, the gradual removal of windows 620 and 625 may be shown in a number of frames shown on the display. The windows 620 and 625 may be shown being removed by, for example, fading out the windows, minimizing the windows, having the windows lift off of the user interface 600, or using other animated effects. By showing the gradual removal of the windows, or other user interface elements, the user may be presented with a more fluid transition from the operating state to the locked state.

According to some aspects, if there are multiple windows on the user interface, the windows may be removed from the user interface one or more at a time or all at once. Other user interface elements may also be removed from the user interface 600 in a similar fashion. For example, icons or links on a desktop on the user interface 600 may fade away as well as buttons or icons on a task bar. According to some aspects, the task bar may also fade away.

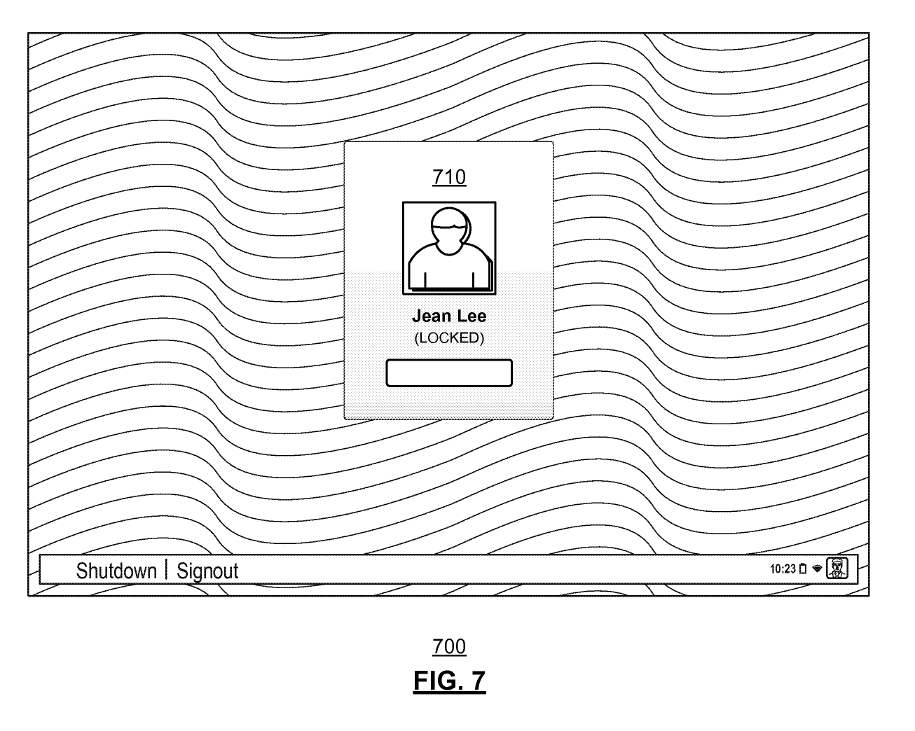

In order to provide a more consistent user experience, according to some aspects, some user interface elements may persist from the operating state to the locked state. FIG. 7 is an illustration of an example user interface 700 showing a user interface for a locked state of a computing device, in accordance with various aspects of the subject technology. In the user interface 700, the windows that were open during the operational state (e.g., windows 620 and 625 in FIG. 6) have been removed. Furthermore, many of the icons on the task bar have been removed.

Although many of the user interface elements have been removed in user interface 700, other user interface elements persist. For example, the task bar and background as seen in FIG. 6 still persist in user interface 700. A clock, a battery/power meter, a Wi-Fi meter, and an icon (e.g., a profile picture) of the logged in user also persist in user interface 700. In some aspects, the user interface 700 may also include a login option 710 for the that is currently logged in. The login option 710 may further indicate that the computing device is currently in a locked state. The login option 710 may appear automatically when the computing device enters a locked state or in response to detecting a user interaction (e.g., a movement of a cursor or an actuation of a keyboard key) while the computing device is in the locked state.

In some aspects, some of the user interface items that persist from the operational state to the locked state may move from one location on the user interface to another location. If the user interface items are moved, the computing device may show the movement of the user interface elements from the one location to the other.

Although some aspects refer to the transition from an operational state of a computing device to a locked state, other aspects may apply to transitions from other states of the computing device. Other transitions may include, for example from an operation state to a logged off state, from an operation state to a shut down state, from a locked to a logged off state, from a locked to a shut down state, from a logged off state to a shut down state, or any other transition.

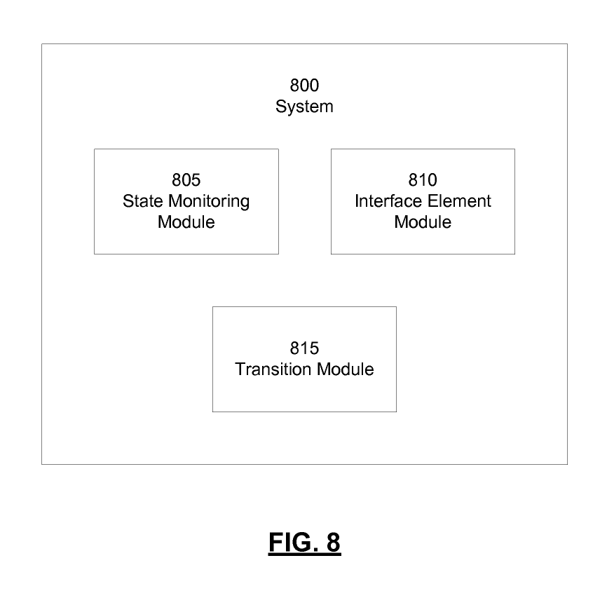

FIG. 8 is a block diagram illustrating an example system 800 configured to provide a transition from a user interface displayed during a first computing state to a user interface displayed during a second computing state, in accordance with various aspects of the subject technology. The system 800 may include a state monitoring module 805, an interface element module 810, and a transition module 815. In other aspects, however, the system may include additional modules, alternative modules, or fewer modules.

The state monitoring module 805 is configured to facilitate the transition from one computing state of a computing machine to another computing state by receiving instructions to change the computing state. The instructions may be generated in response to user instructions (e.g., a user logging out or locking the computing machine) or automatically by the operating system of the computing machine in response to certain conditions being met (e.g., going 15 minutes without user interaction).

When the computing machine is to transition from one computing state to another, the interface element module 810 can identify user interface elements the a user interface being displayed to the user that are to be removed and user interface elements that are not to be removed (e.g., persisted) when the computing machine transitions to the new computing state. In some aspects, the interface element module 810 may determine which user interface elements are to be removed and which user interface elements are to be persisted based on the type of the user interface element. For examples, windows for running applications may be removed while the main task bar and the desktop background may be persistent. Furthermore, even though the main task bar may not be removed, icons on the main task bar can be removed.

In other aspects, the interface element module 810 may determine which user interface elements are to be removed and which user interface elements are to be persisted based on other factors such as where the interface elements are located or a priority score for each of the interface elements. For example, icons on a desktop may be removed while icons on the task bar may be persisted.

The transition module 815 is configured to transition the user interface displayed during the first computing state to a user interface displayed during the second computing state by, for example, removing the user interface elements that are to be removed without removing the user interface elements that are to be persisted. The user interface elements may be removed gradually over a period of time. For example, user interface elements may fade away one by one or at the same time. Furthermore, one or more of the user interface elements that are to be persisted may be moved from one location to another. These interface elements may be moved gradually all at the same time or one by one.

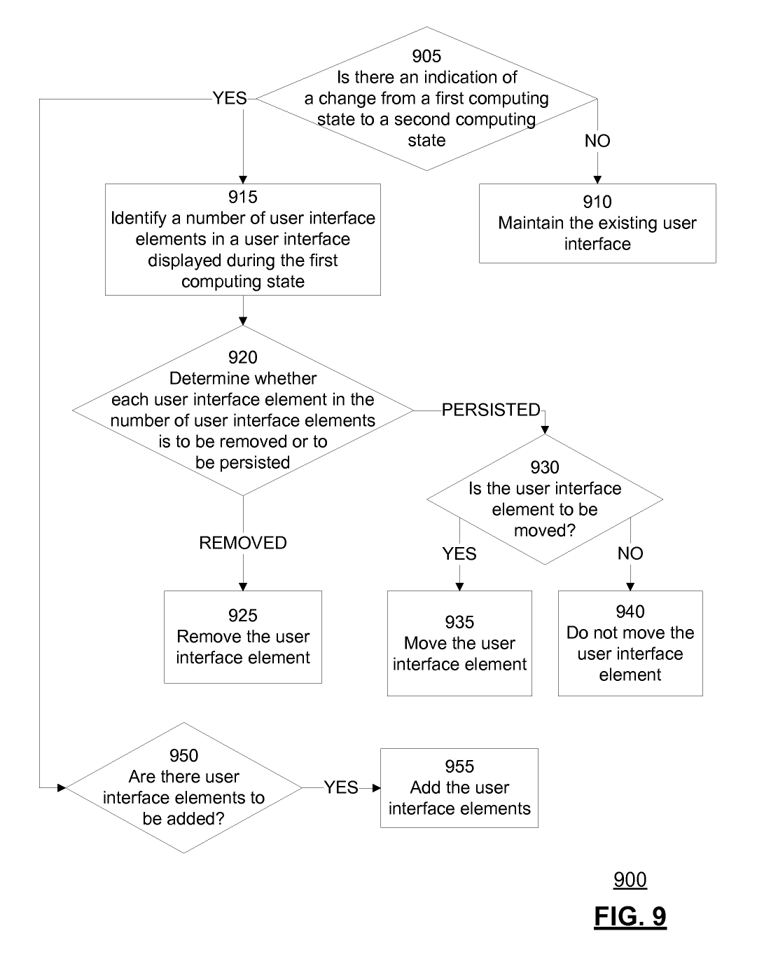

FIG. 9 is a flow chart illustrating an example process 900 for providing a transition from a user interface displayed during a first computing state to a user interface displayed during a second computing state, in accordance with various aspects of the subject technology. Although the blocks shown in FIG. 9 are described with reference to the components of the system 800 in FIG. 8, the blocks are not limited to being performed by these components. In addition, although the blocks in process 900 are shown in a particular order, certain blocks may be executed in different orders or at the same time.

At block 905, the state monitoring module 805 may determine whether or not there is an indication of a change from a first computing state (e.g., an operational state) in a computing device to a second computing state (e.g., a locked state) in the computing device. For example, an indication of a change may be received from the operating system in response to, for example, a user instructing the computing device to go into a locked state or based on detecting a condition for going into a locked state (e.g., no user interaction for a threshold period of time).

If there is no indication of a change in computing state, at block 910, the existing user interface may be maintained. On the other hand, if there is an indication of a change in computing state, at block 915, the interface element module 810 may identify a number of user interface elements in a user interface displayed during the first computing state. For each identified user interface element, the interface element module 810, can determine the user interface element is to be removed or persisted at block 920. According to some aspects, user interface elements of certain types (e.g., windows or icons) are to be removed while other interface elements (e.g., a task bar or a background) are persistent.

If the user interface element is to be removed, at block 925, the transition module 815 can display the removal the user interface element. As described above, the removal of the user interface element may occur gradually. For example, as described above, the user interface elements may be minimized, fade out, or be lifted off of the user interface. If, on the other hand, the user interface element is to be persisted, at block 930, the transition module 815 can determine whether the persisted user interface element is to be moved to a new location for the new computing state.

Furthermore, according to some aspects, if there is an indication of a change from a first computing state to a second computing state, the interface element module 810 can determine whether additional user interface elements are to be added for the second computing state or for the transition to the second computing state at block 950. If additional interface elements (e.g., a login option or an interface element indicating the new computing state) are to be added, they may be added at block 955. For example, an overlay interface element may be added on top of the background to visually reinforce the locked state. The overlay may cause the background to appear darkened, yet still visible to a user.

If the persisted user interface element is to be moved, the transition module 815, at block 935 can move the user interface element to it's new location. If the persisted user interface element is not to be moved, at block 940, the transition module 815 does not move the user interface element.

After the transition module 815 transitions the user interface displayed during the first computing state to a user interface displayed during the second computing state, the computing machine can continue to operate in the second computing state. For example, if the computing machine transitioned from a operational state to a locked state, a user interface with a user log on screen or a login screen may appear. Accordingly the user who locked the computing machine may unlock the computing machine or, in another variation, another user may login to the computing machine. As described above, the user interface may appear with one or more user login options and the user login option corresponding to the last successfully logged in user may appear selected (see user interface 200 in FIG. 2).

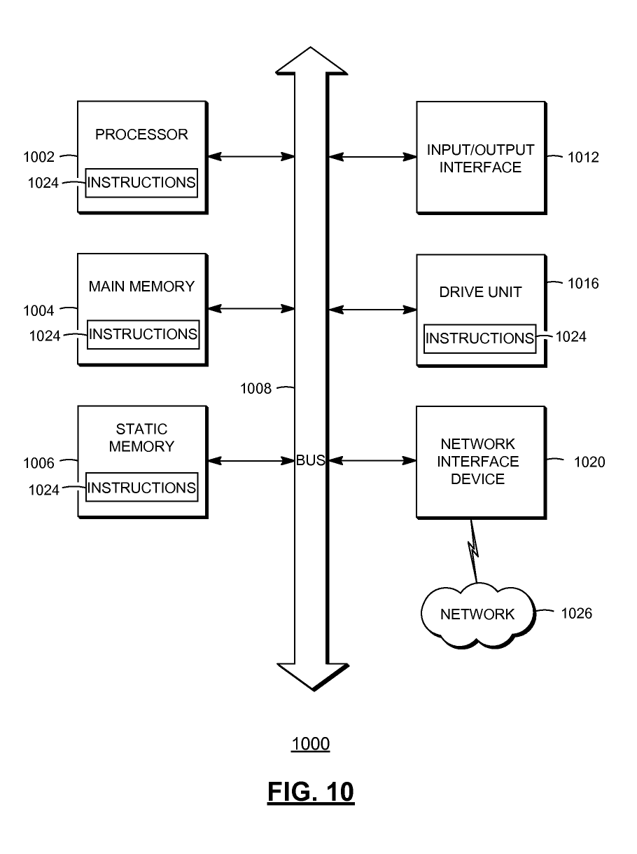

FIG. 10 is a block diagram illustrating an example computer system with which any of the computing machines, devices, or systems discussed herein may be implemented, in accordance with some aspects of the subject technology. In certain aspects, the computer system 1000 may be implemented using hardware or a combination of software and hardware, either in a dedicated server, or integrated into another entity, or distributed across multiple entities.

The example computer system 1000 includes a processor 1002, a main memory 1004, a static memory 1006, a disk drive unit 1016, and a network interface device 1020 which communicate with each other via a bus 1008. The computer system 1000 may further include an input/output interface 1012 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 1002 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 1024 embodying any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting machine-readable media. The instructions 1024 may further be transmitted or received over a network 1026 via the network interface device 1020.

The machine-readable medium may be a single medium or multiple media (e.g., a centralized or distributed database, and/or associated caches and servers) that store the one or more sets of instructions. The machine-readable medium may include the drive unit 1016, the static memory 1006, the main memory 1004, the processor 1002, an external memory connected to the input/output interface 1012, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

The various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A computer-implemented method for providing a customized background in a user interface based on a selection of a user login option, the method comprising:
identifying at least a first user and a second user of a computing machine;
displaying a first background for the first user in a user login interface comprising at least a first user login option for the first user and a second user login option for the second user;
receiving a selection of the second user login option for the second user; and
replacing, in response to the receiving of the selection, the first background for the first user in the user login interface with a second background for the second user.

2. The computer-implemented method of claim 1, wherein the first user login option includes at least one of a user name and a profile picture for the first user and the second user login option includes at least one of a user name and a profile picture for the second user.

3. The computer-implemented method of claim 1, wherein the first user is a user that most recently logged into the computing machine.

4. The computer-implemented method of claim 1, wherein the first user is a user with a most recently selected user login option prior to the receiving of the selection of the second user login option.

5. The computer-implemented method of claim 1, wherein the replacing of the first background with the second background comprises gradually fading out the first background and gradually fading in the second background in the user login interface.

6. The computer-implemented method of claim 1, wherein the replacing of the first background with the second background comprises minimizing the first background and maximizing the second background in the user login interface.

7. The computer-implemented method of claim 1, wherein the replacing of the first background with the second background is delayed until there is no change in the selection of the second user login option for a predetermined period of time.

8. The computer-implemented method of claim 1, wherein the replacing of the first background with the second background comprises:
retrieving the second background from a non-encrypted portion of memory accessible during the booting stage of the computing machine; and
decoding the second background using a secure decoding library.

9. The computer-implemented method of claim 1, further comprising:
replacing, in response to the receiving of the selection of the second user login option, at least one other user interface element for the first user with at least one other user interface element for the second user.

10. The computer-implemented method of claim 9, wherein the other user interface element includes at least one of a task bar, an icon, an application list, or a utility tray.

11. A system for providing a customized background in a user interface based on a selection of a user login option, the system comprising:
one or more processors; and
a machine-readable medium comprising instructions stored therein, which when executed by the one or more processors, cause the one or more processors to perform operations comprising:
identifying at least a first user and a second user of a computing machine;
displaying a first interface element for the first user in a user login interface comprising at least a first user login option for the first user and a second user login option for the second user;
receiving a selection of the second user login option for the second user; and
replacing, in response to the receiving of the selection, the first interface element for the first user in the user login interface with a second interface element for the second user.

12. The system of claim 11, wherein the first interface element is a background for the first user and the second interface element is a background for the second user.

13. The system of claim 11, wherein the first user is a user that most recently logged into the computing machine.

14. The system of claim 11, wherein the first user is a user with a most recently selected user login option prior to the receiving of the selection of the second user login option.

15. The system of claim 11, wherein the replacing of the first background with the second background comprises gradually fading out the first background and gradually fading in the second background in the user login interface.

16. The system of claim 11, wherein the replacing of the first background with the second background is delayed until there is no change in the selection of the second user login option for a predetermined period of time.

17. The system of claim 11, wherein the replacing of the first background with the second background comprises:
retrieving the second background from a non-encrypted portion of memory accessible during the booting stage of the computing machine; and
decoding the second background using a secure decoding library.

18. A machine-readable medium comprising instructions stored therein, which when executed by a machine, cause the machine to perform operations comprising:
identifying at least a first user and a second user of a computing machine, wherein the first user is a user that most recently logged into the computing machine;
displaying a first background for the first user in a user interface comprising at least a first user login option for the first user and a second user login option for the second user;
receiving a selection of the second user login option for the second user; and
displaying, in response to the receiving of the selection, a second background for the second user in the user interface.

19. The machine-readable medium of claim 18, wherein the displaying of the second background comprises gradually fading out the first background and gradually fading in the second background in the user login interface.

20. The machine-readable medium of claim 18, wherein the displaying of the second background is delayed until there is no change in the selection of the second user login option for a predetermined period of time.
